(19) United States
(12) Patent Application Publication
(10) Pub. No.: US 2003/0034328 A1
(43) Pub. Date: Feb. 20, 2003

(54) METHOD OF MAKING 3D PATTERNS ON A MOLD

(76) Inventor: Pang-Tsung Lu, Taichung (TW)

Correspondence Address: Jackson Walker L.L.P., Suite 2100, 112 E. Pecan Street, San Antonio, TX, 78205, US

(21) Appl. No.: 09/933,212

(22) Filed: Aug. 20, 2001

(51) Int. Cl. B44C 1/22

(52) U.S. Cl. 216/28; 216/58; 216/83; 216/8; 216/9

(57) ABSTRACT

A method of making a 3D pattern on a mold that etches the mold several times with different patterns so as to make the 3D pattern extremely complicated, therefore, the anti-slip and counterfeit-proof characteristics of products shaped in the mold are improved.

### BACKGROUND OF THE INVENTION

1. Field of the Invention

The present invention relates to a method of making 3D patterns on a mold, and more particularly to a method that etches the mold several times in different patterns so as to produce 3D patterns on the mold.

2. Description of Related Art

Adding patterns to a mold that increases texture quality of surfaces of a product shaped in the mold provides benefits such as added value of the shaped product. For example, molding metal ornaments or artificial leather with some specific patterns imitates the surface textures of real wood or leather. Molding a shoe pad or shoe sole with grooving patterns provides an anti-slip efficiency to shoes. Additionally, molding cases of medical equipment to reflect light waves or light-resisting boards with perspective geometric patterns further provides light-transmitting monitoring efficiency or counterfeit-proof efficiency for some high-tech products.

Conventional simple molds have smooth surfaces or only shallow patterns on the surface, therefore, these molds can not provide a counterfeit-proof characteristic, and the anti-slip efficiency of the shaped product is not adequate. Therefore, added values of the shaped product are not promoted.

For those reasons, the present invention has arisen to mitigate and/or obviate the disadvantages of the conventional simple mold.

### SUMMARY OF THE INVENTION

The main objective of the present invention is to provide a method of making 3D patterns on a mold wherein the product shaped in the mold has enhanced anti-slip and counterfeit-proof characteristics.

Further benefits and advantages of the present invention will become apparent after a careful reading of the detailed description with appropriate reference to the accompanying drawings.

### BRIEF DESCRIPTION OF THE DRAWINGS

FIG. 1 is a schematic flow chart of a method of making 3D pattern on a mold in accordance with the present invention;

FIG. 2 is a top plan view of a first pattern board used in this invention;

FIG. 3 is a top plan view of a second pattern board used in this invention;

FIG. 4 is a top plan view of surface of a mold after etching with the first pattern and the second pattern;

FIG. 5 is a partially enlarged perspective view of the etched mold in accordance with FIG. 4; and

FIG. 6 is a top plan view of an embodiment of a mold with a hidden pattern.

### DETAILED DESCRIPTION OF THE INVENTION

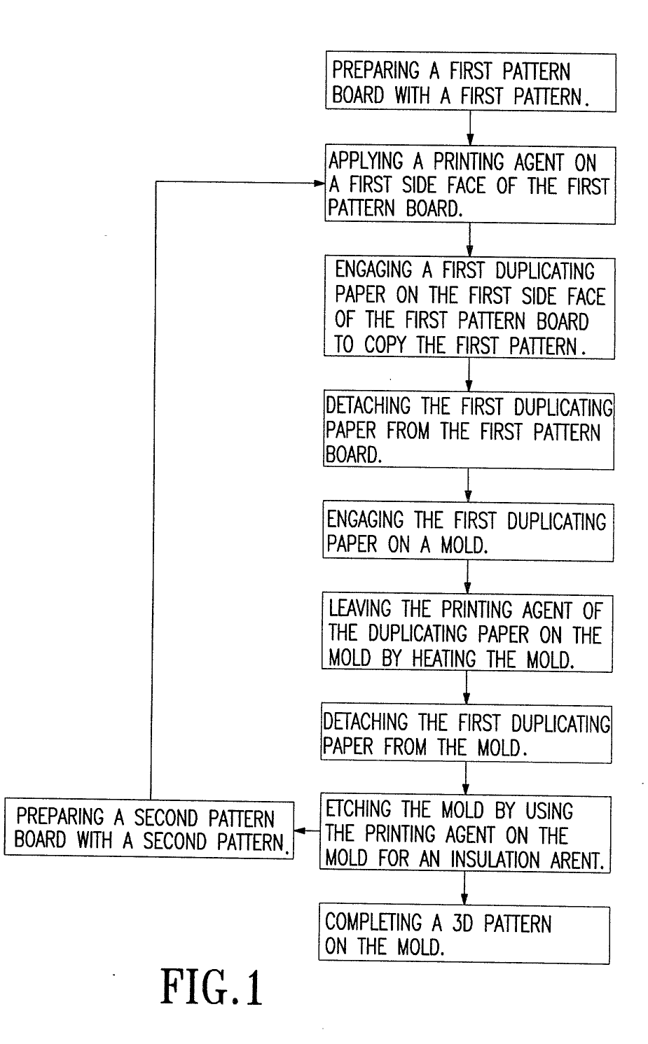

With reference to FIG. 1, a method of making 3D pattern on mold comprises following steps:

Preparing a first pattern board with a first pattern;

Applying a printing agent such as printing ink or glue on a first side face of the first pattern board;

Engaging a duplicating paper such as gummed tape or adhesive paper on the first side face of the first pattern board to copy the first pattern from the first pattern board;

Detaching the duplicating paper from the first pattern board;

Engaging the duplicating paper on the mold whereby the first pattern is transferred to the mold;

Leaving ink of the duplicating paper on the mold by heating the mold;

Detaching the duplicating paper from the mold by hand or by washing that the first pattern is detained on the mold;

Etching the mold by using the printing agent on the mold for an insulation agent so as to form the first pattern of the first pattern board on a periphery of the mold;

Preparing a second pattern board with a second pattern;

Applying the printing agent such as printing ink or glue on a first side face of the second pattern board;

Engaging a duplicating paper such as gummed tape or adhesive paper on the first side face of the second pattern board to copy the second pattern from the second pattern board;

Detaching the duplicating paper from the second pattern board;

Engaging the duplicating paper on a mold whereby the second pattern is transferred to the mold;

Leaving ink of the duplicating paper on the mold by heating the mold;

Detaching the duplicating paper from the mold by hand or by washing that the second patter is detained on the mold;

Etching the mold by using the printing agent on the mold for an insulation agent so as to form the second pattern of the second pattern board on a periphery of the mold, whereby the second pattern overlaps the first pattern;

Repeating the above processes to transfer multiple patterns to the mold and define a third pattern, a fourth pattern and so on to the mold over and over again, until a desired 3D pattern on the mold is completed.

When the pattern board is made from zinc board or copper board, printing ink is applied on the zinc board or copper board. Then, the adhesive tape or adhesive paper is pasted on the pattern board to transfer the pattern to the mold.

When the pattern board is made from resin board, printing ink is applied on the resin board. Then the adhesive paper is pasted on the pattern board to transfer the pattern to the mold.

When the pattern board is a halftone, glue is applied on the halftone and then the adhesive paper becomes the duplicating paper to transfer the pattern to the mold.

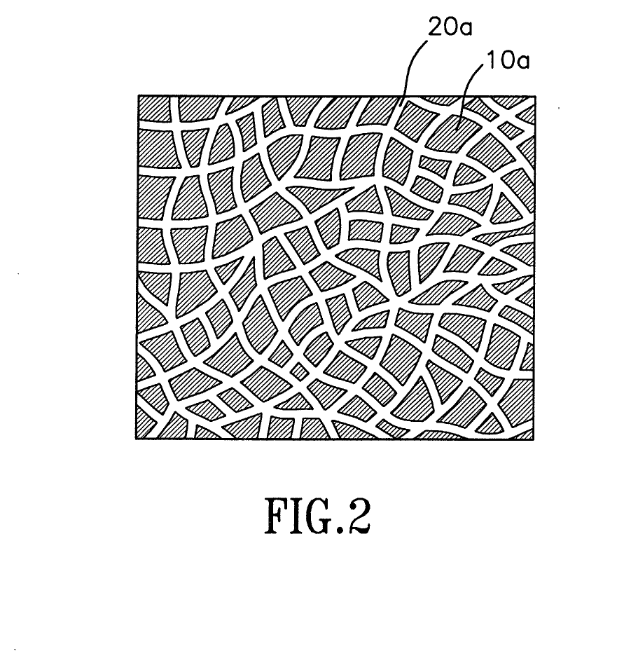

Variations of the etched mold are illustrated in accordance with FIGS. 2-5. FIG. 2 shows a first pattern board wherein the pattern is composed of ink areas (10a) and non-ink areas (20a). When the first pattern is copied to the mold, the ink areas (10a) in left oblique lines are covered with printing ink and protected by the printing ink so that the ink areas (10a) are not etched during an etching process. On the contrary, the non-ink area (20b) are not covered with printing ink so as to be etched during the etching process to define concave portions.

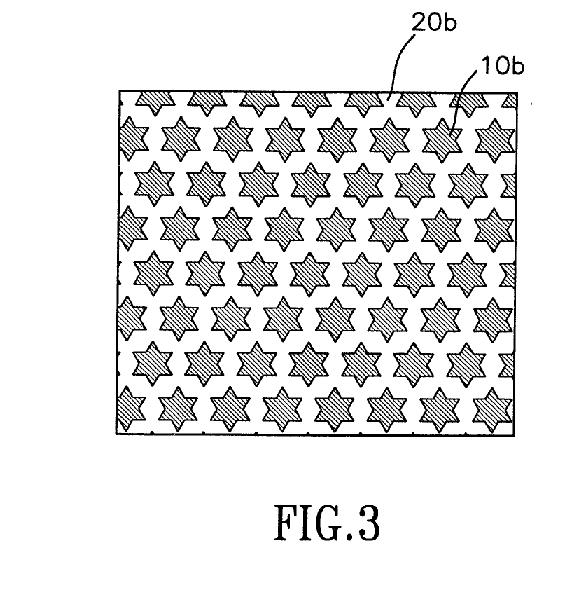

FIG. 3 shows a second pattern board wherein the pattern is also composed of ink areas (10b) and non-ink areas (20b). When the second pattern is copied to the mold, the ink areas (10b) are covered with printing ink and protected by the printing ink so that the ink areas (10b) in right oblique lines are not etched during the etching process. On the contrary, the non-ink areas (20b) are not covered with printing ink so as to be etched during the etching process to perform concave portions.

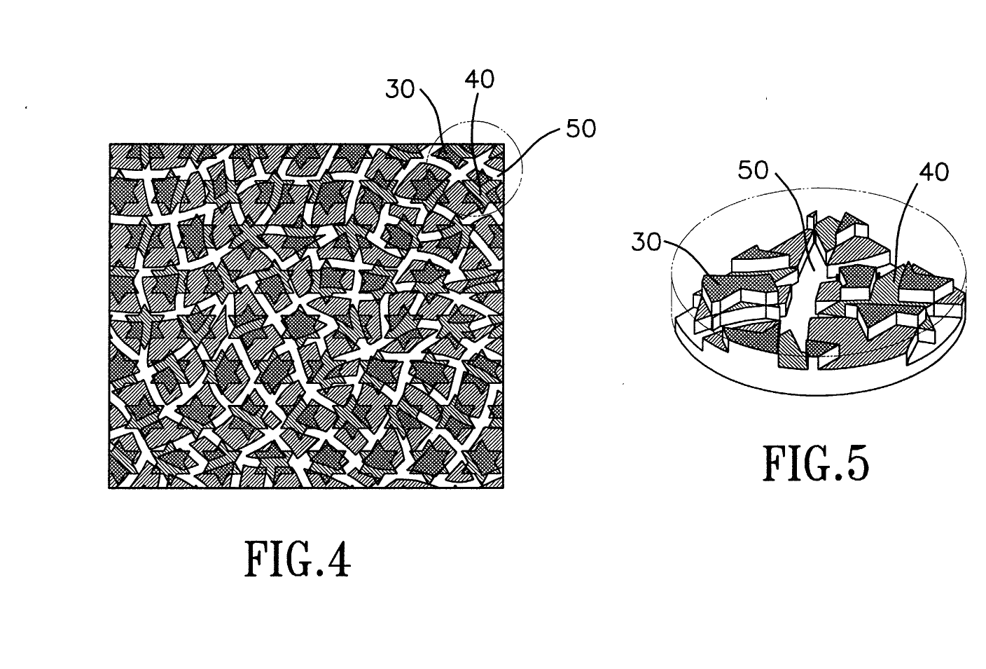

Therefore, the mold is etched with two patterns of the first pattern board and the second pattern board. The surface of the etched mold is shown in FIGS. 4 and 5, wherein covered areas (30) with both right and left oblique lines are protected during two performances of the etching processes because the printing agent protects the covered areas (30). Single etching areas (40) only in right or left oblique lines are etched once so that heights of the single etching areas (40) are lower than heights of the covered areas (30). Double etching areas (50), blank areas, are etched twice during the etching processes and have the lowest height compared with the covered areas (30) and the single etching area (40).

It is easy to be understood that when etching times of the mold increase, the pattern on the surface of the mold becomes irregular because the different patterns are overlapped over and over. The depth of the concave portion becomes sufficiently deep to make the 3D pattern on the mold.

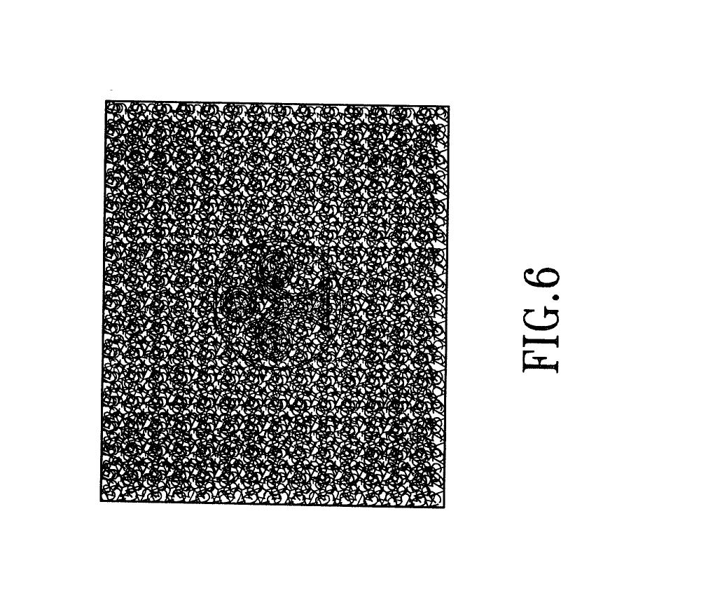

FIG. 6 shows an embodiment wherein the pattern is designed to hide a trademark inside after etching with several patterns. The pattern of the mold is extremely complicated so that the pattern is not easy to be counterfeited. Additionally, the anti-slip efficiency of shaped product in the mold is improved when the depth of 3D pattern on the mold is enhanced.

Although the invention has been explained in relation to its preferred embodiment, it is to be understood that many other possible modifications and variations can be made without departing from the spirit and scope of the invention as hereinafter claimed.

What is claimed is:

1. A method of making a 3D pattern on a mold, the method comprising the following acts:
preparing a first pattern board with a first pattern thereon;
applying a printing agent on a first side face of the first pattern board;
engaging a first duplicating paper on the first side face of the first pattern board to copy the first pattern;
detaching the first duplicating paper from the first pattern board;
engaging the first duplicating paper on the mold;
leaving the printing agent of the first duplicating paper on the mold by heating the mold.;
detaching the first duplicating paper from the mold that the printing agent is detained on the mold;
etching the mold by using the printing agent on the mold for an insulation agent so as to form the first pattern of the first pattern board on a periphery of the mold;
preparing a second pattern board with a second pattern thereon;
applying the printing agent on a first side face of the second pattern board;
engaging a second duplicating paper on the first side face of the second pattern board to copy the second pattern;
detaching the second duplicating paper from the second pattern board;
engaging the second duplicating paper on the periphery of the mold with the first pattern etching thereon;
leaving the printing agent of the second duplicating paper on the mold by heating the mold;
detaching the second duplicating paper from the mold that the printing agent is detained on the mold; and
etching the mold by using the printing agent on the mold for an insulation agent so as to form the second pattern of the second pattern board on a periphery of the mold; whereby a 3D pattern is formed on the mold.

2. The method of making a 3D pattern on a mold as claimed in claim 1, wherein the printing agent is printing ink.

3. The method of making a 3D pattern on a mold as claimed in claim 1, wherein the printing agent is glue.

4. The method of making a 3D pattern on a mold as claimed in claim 1, wherein the duplicating paper is an adhesive tape.

5. The method of making a 3D pattern on a mold as claimed in claim 1, wherein the duplicating paper is an adhesive paper.
